(19) United States
(12) Patent Application Publication
(10) Pub. No.: US 2007/0000221 A1
(43) Pub. Date: Jan. 4, 2007

(54) Air purifier

(76) Inventors: Chan Jung Park, Suwon-si (KR); Young Saeng Kim, Incheon-City (KR); Sun A Oh, Seoul (KR)

Correspondence Address: STANZIONE & KIM, LLP, 919 18TH STREET, N.W., SUITE 440, WASHINGTON, DC, 20006, US

(21) Appl. No.: 11/363,205

(22) Filed: Feb. 28, 2006

(30) Foreign Application Priority Data
Jun. 30, 2005 (KR) 2005-58106

(51) Int. Cl. B01D 46/00

(52) U.S. Cl. 55/471

(57) ABSTRACT

An air purifier designed to allow dust collected on a surface of a dust filter therein to be conveniently and rapidly removed from the dust filter without separating the dust filter from the air purifier unit. The air purifier includes a vibrating member equipped adjacent to the dust filter, and a vibration motor assembly equipped to the vibrating member to remove dust attached to the dust filter through vibratory motion. The dust filter is equipped at an angle within the housing for the air purifier such that an upper end of the dust filter is closer to a front side of the housing than a lower end of the dust filter. The air purifier may further include a tray equipped below the dust filter to collect the dust that drops from the dust filter when the dust filter is vibrated by vibration of the vibrating member. The tray has a rear plate extending towards the lower end of the dust filter to prevent the dust collected in the tray from being scattered and then reattached to the dust filter. One or more surfaces of the dust filter may be coated to prevent static electricity from accumulating thereon so as to easily remove the dust.

### CROSS-REFERENCE TO RELATED APPLICATIONS

This application claims the benefit of Korean Patent Application No. 2005-58106, filed on Jun. 30, 2005 in the Korean Intellectual Property Office, the disclosure of which is incorporated herein by reference in its entirety.

### BACKGROUND

1. Field of the Present General Inventive Concept

The present general inventive concept relates to an air purifier and, more particularly, to an air purifier that is designed to allow dust collected on a dust filter therein to be removed conveniently, rapidly and automatically.

2. Description of the Related Art

Generally, an air purifier comprises filters to purify air and a blowing fan to forcibly blow the air within a housing for the air purifier. When the air purifier is operated to purify indoor air, the blowing fan forces the indoor air to pass through the filters to filter out dust, odor, and bacteria contained in the air passing through the filters, and then forces purified air to be discharged into a room.

It is necessary for the air purifier to have a compact structure for convenient installation at a suitable location in the room. It is also necessary for the air purifier to have a high purifying capability. For this purpose, typical air purifiers are provided with various filters which exhibit high filtering, deodorizing, and/or sterilizing performance.

A dust filter is used in an air purifier to remove dust and foreign substances contained in the air to be purified. The dust filter is generally formed of a material having numerous fine pores so that when the air flows through the fine pores, the dust and foreign substances contained in the air are collected on a surface of the dust filter, thereby cleaning the air.

One example of conventional air purifiers having such a dust filter is disclosed in U.S. Pat. No. 5,702,507. The air purifier of this U.S. patent comprises a dust filter and a blowing fan equipped within a case. The air purifier is designed to remove dust from air passing through the dust filter to purify the air.

However, when such a conventional air purifier is used for a predetermined period of time or longer, the surface of the dust filter is covered with the dust and then becomes blocked. This results in a significant decrease in the amount of dust blown by the air purifier, which, in turn, results in generation of severe noise in the air purifier. Thus, it is seen that the conventional air purifier has drawbacks in that the dust filter is required to be periodically separated from the air purifier housing or assembly for maintenance to remove dust collected in the dust filter. Such a requirement causes inconvenience because if the dust is not periodically removed from the dust filter, the lifetime of the dust filter will be decreased.

In particular, for the conventional air purifier as described above, dust particles are not easily detached from the dust filter due to electrostatic force generated on the surface of the dust filter. Thus, it is very difficult to remove the dust from the dust filter. Furthermore, some dust particles are often stuck to the dust filter, and are not easily detached from the dust filter, thereby deteriorating the filtering performance of the dust filter while significantly increasing the load on the blowing fan.

### SUMMARY

The present general inventive concept provides an air purifier designed to allow dust collected on a dust filter to be conveniently and rapidly removed from the dust filter without physically separating the dust filter.

The present general inventive concept also provides an air purifier designed to prevent static electricity from accumulating on the surface of the dust filter and to allow the dust to be easily detached from the dust filter.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an air purifier, which comprises a housing that includes a dust filter; a vibrating member placed adjacent to the dust filter and transferring vibratory motion thereto when the vibrating member is vibrated; and a vibration motor assembly equipped to the vibrating member and configured to vibrate the vibrating member to remove dust attached to the dust filter.

The dust filter may be equipped at an angle within the housing such that an upper end of the dust filter is closer to a front side of the housing than a lower end of the dust filter, wherein the angle is measured from a vertical direction.

The dust filter may be equipped at an angle of 10 to 45 degrees within the housing.

The air purifier may further include a tray placed adjacent to the lower end of the dust filter to collect the dust dropping from the dust filter when the dust filter is vibrated by vibration of the vibrating member.

The tray may have a rear plate extending towards the lower end of the dust filter to prevent the dust collected in the tray from being scattered and then reattached to the dust filter.

The surface of the dust filter may be coated to prevent static electricity from accumulating thereon so as to easily remove the dust therefrom.

The surface of the dust filter may be coated by applying Teflon powder or metallic powder to the surface of the dust filter.

The foregoing and/or other utilities of the present general inventive concept may also be achieved by providing a dust filter that is equipped at an angle within the housing such that an upper end of the dust filter is closer to a front side of the housing than a lower end of the dust filter, wherein the angle is measured from the vertical. The housing also includes a tray placed adjacent to the lower end of the dust filter to collect the dust dropping from the dust filter.

The foregoing and/or other utilities of the present general inventive concept may also be achieved by providing a system that includes a housing having a slot on an external side portion thereof, and a dust filter configured to be inserted into or removed from the housing through the slot, wherein, upon insertion into the housing, the dust filter is placed at an angle within the housing such that an upper end of the dust filter is closer to a front side of the housing than a lower end of the dust filter, wherein the angle is measured from the vertical. The system also includes a vibration unit placed inside the housing and adjacent to the dust filter when the dust filter is inserted into the housing, wherein the vibration unit is configured to remove dust attached to the dust filter through vibratory motion thereof.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a front perspective view illustrating an air purifier with a dust filter equipped at an angle therein in accordance with an embodiment of the present general inventive concept;

FIG. 2 is a longitudinal cross-section view of the air purifier of FIG. 1 illustrating the air purifier with a vibrating member and a vibration motor assembly disposed to a rear portion of the dust filter;

FIG. 3 is a perspective view illustrating the vibrating member and the vibration motor assembly shown in FIG. 2; and

FIG. 4 is a perspective view illustrating an inner structure of the vibration motor assembly shown in FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

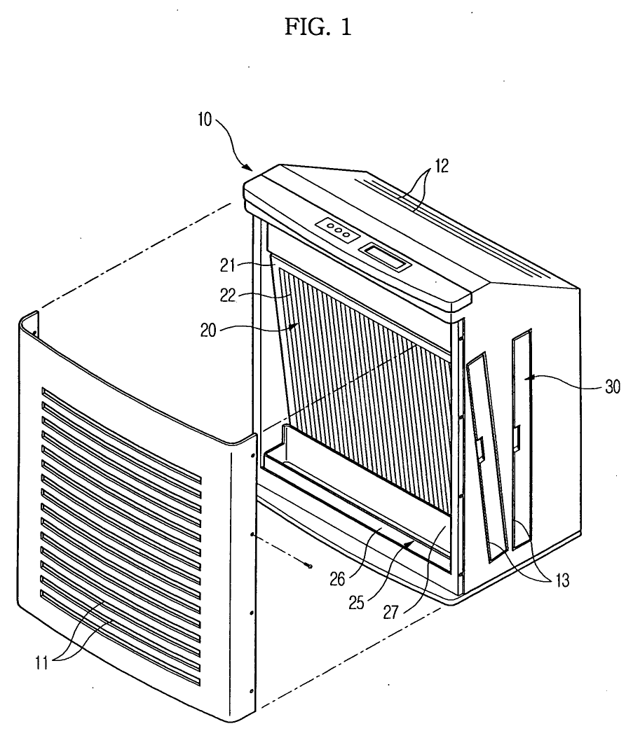

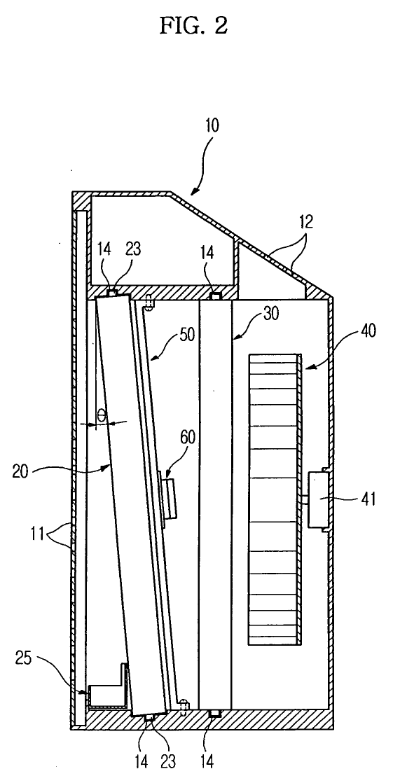

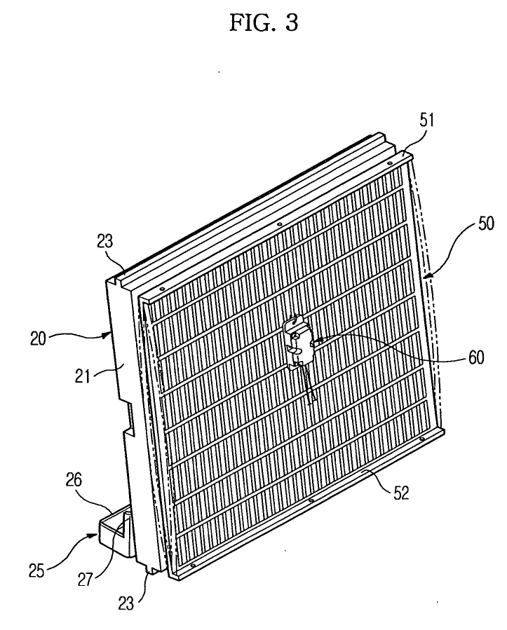

In the discussion below, FIG. 1 is a front perspective view illustrating an air purifier 10 with a dust filter 20 equipped at an angle therein in accordance with an embodiment of the present general inventive concept, FIG. 2 is a longitudinal cross-section view of the air purifier 10 of FIG. 1 illustrating the air purifier with a vibrating member 50 and a vibration motor assembly 60 disposed to a rear portion of the dust filter 20, and FIG. 3 is a perspective view illustrating the vibrating member 50 and the vibration motor assembly 60 shown in FIG. 2. It is noted here that the same reference numeral “10” is used herein to interchangeably refer to the air purifier and a box-shaped housing of the air purifier according to one embodiment of the present general inventive concept.

As shown in FIGS. 1 to 3, the air purifier 10 according to an embodiment of the present general inventive concept includes a box-shaped housing 10 defining an appearance of the air purifier, a dust filter 20 equipped or fitted inside the housing 10 to filter out dust and foreign substances contained in the air to be purified, a blowing fan 40 equipped to the rear of the dust filter 20 within the housing 10 to forcibly blow air, a vibrating member 50 equipped adjacent a rear side (i.e., the side of the dust filter 20 facing the fan 40) of the dust filter 20, and a vibration motor assembly 60 coupled to the vibrating member 50 to vibrate the vibrating member 50.

In the embodiment of FIG. 3, the air purifier 10 of the present general inventive concept may further include a deodorizing filter 30 that may be placed between the dust filter 20 and the blowing fan 40 to remove odors contained in the air to be purified. Additionally or alternatively, the air purifier of the present general inventive concept may further include other filters in addition to the deodorizing filter 30 to perform sterilization and anti-bacterial functions as desired.

A front surface (i.e., the surface that is opposite to the surface where the fan 40 is mounted) of the housing 10 may be formed with a plurality of air inlets 11 (as seen in FIGS. 1 and 2) through which indoor air flows into the housing 10. The top surface of the housing may contain a plurality of air outlets 12 (as shown in FIGS. 1-2) through which purified air is discharged to a room.

It is observed here that the air inlets 11 and the air outlets 12 may be positioned to other locations of the housing 10 depending on the disposition of the dust filter 20, the deodorizing filter 30, and the blowing fan 40 within the housing 10.

In an embodiment, slots 13 are formed on one side of the housing 10 (as shown, for example, in FIG. 1) such that the dust filter 20 and the deodorizing filter 30 can be inserted into or separated from the housing 10 therethrough. To facilitate such insertion or removal, slide grooves 14 (FIG. 2) may be formed on upper and lower internal surfaces of the housing 10 such that the dust filter 20 and the deodorizing filter 30 can be slidably engaged with or disengaged from the housing 10 by movement along the slide grooves 14. In an alternative embodiment, a filter (e.g., a sterilization filter) other than the deodorizing filter 30 may also be inserted into or removed from the housing through the corresponding slot 13. Alternatively, the housing 10 may contain more than two slots to accommodate other filters in addition to the deodorizing filter 30.

The blowing fan 40 may include a centrifugal fan having a plurality of radially arranged plates, such as a Sirocco fan, and is rotated at a high speed by a driving motor 41 to force indoor air to flow into the housing 10 and circulate therein.

In the embodiment shown in FIG. 1, the dust filter 20 includes a rectangular frame 21, and a filtering portion 22 fitted into the frame 21 to collect dust. In an alternative embodiment, the filtering portion 22 may be an integral part of the rectangular frame 21. The frame 21 may have slide protrusions 23 (as shown in FIG. 2) formed on upper and lower ends thereof so as to allow the frame 21 (and, hence, the dust filter 20) to be fitted into the slide grooves 14 and also to guide sliding in/out of the dust filter 20 through the grooves 14.

Although not clearly shown in the drawings, the filtering portion 22 may be detachably coupled to the frame 21 for easy separation therefrom (e.g., during cleaning of the filter 20). In an embodiment, the filtering portion 22 is formed of a porous material having numerous fine pores to prevent fine dust particles from passing through the filtering portion 22.

In another embodiment, one or more external surfaces of the filtering portion 22 may be appropriately coated to prevent the dust particles from being stuck thereon due to electrostatic force accumulated on the surface of the filtering portion 22. One example of the coating is Teflon® powder or metallic powder that can be applied to a surface of the filtering portion 22 to prevent the static electricity from accumulating on the surface of the filtering portion 22. In an embodiment, the entire surface area of a surface of the filtering portion 22 may be coated to prevent the static electricity from accumulating thereon, so that the dust can be easily removed from the surface of the filtering portion 22.

It is shown in the embodiment of FIG. 2 that the dust filter 20 may be equipped at an angle “θ” (measured from the vertical) inside the housing 10 such that the upper end of the dust filter 20 is closer to the front surface of the housing 10 than the lower end of the dust filter 20. Such tilted arrangement of the dust filter 20 allows for the dust attached to the surface of the dust filter unit 20 to be directly dropped to the bottom of the housing 10 without flowing down along a surface of the housing 10 especially when the vibrating member 50 is operated in the housing 10 as described below.

It is observed here that if the dust filter 20 is equipped in the housing 10 at an excessively large angle θ, it consumes too much a space in the housing 100. On the other hand, if the dust filter 20 is equipped in the housing 10 at too small an angle θ, the dust does not easily drop to the bottom of the housing 10. Thus, preferably, the dust filter 20 is equipped in the housing 10 at an angle θ in the range of approximately 10 to 45 degrees.

In the embodiment of FIGS. 1-3, the air purifier 10 is shown to further include an elongated rectangular box-shaped tray 25 equipped below the dust filter 20 and open at an upper portion facing the dust filter 20 so as to collect therein the dust and foreign substances dropped from the dust filter 20. The tray 25 has a front plate 26, and a rear plate 27 extending above the front plate 26 to prevent the dust collected in the tray 25 from being scattered upward from the tray 25 and then reattached to the surface of the dust filter 20 by suction force of the blowing fan 40. With this structure, the rear plate 27 of the tray 25 slightly screens or blocks the lower portion of the filtering portion 22 of the dust filter 20 as shown, for example, in FIG. 1.

With such a structure of the tray 25, when a considerable suctioning force of air is generated on the front surface (i.e., the surface facing the tray 25) of the dust filter 20 via operation of the blowing fan 40, the dust collected in the tray 25 is prevented from being scattered upward from the tray 25 and then being reattached to the filtering portion 22 of the dust filter 20.

In one embodiment, the vibrating member 50 may be a thin resilient lattice-shaped plate. In the embodiment of FIG. 3, the vibrating member 50 has upper and lower ends 51 and 52, respectively, fastened to the internal upper and lower portions of the housing 10 by screws. As shown in FIGS. 2-3, the vibrating member 50 may be located very close to the rear surface (i.e., the surface facing the blowing fan 40) of the dust filter 20 so that the vibrational movement of the vibrating member 50 is conveyed to the rear surface of the dust filter 20. In an embodiment, the vibrating member 50 is formed of a plastic material having good resilience, and is vibrated by the vibration motor assembly 60 operated to strike the rear surface of the vibrating member 50 to produce vibrations thereof. In an embodiment, the vibrating member 50 may periodically, physically contact the rear surface of the dust filter 20 during its vibratory motion, thereby transmitting the vibrations to the dust filter 20.

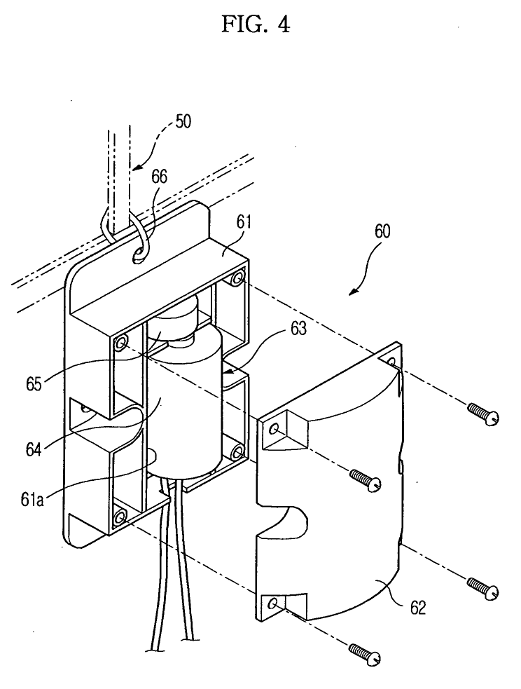

FIG. 4 is a perspective view illustrating an inner structure of the vibration motor assembly 60 shown in FIG. 3. In the embodiment of FIG. 4, the vibration motor assembly 60 includes a case 61 tightly fixed at upper and lower portions thereof to the lattice of the vibrating member 50 by a metal strip 66 (only the upper portion fixing via strip 66 is visible in FIG. 4), a vibration motor 63 located within the case 61, and a cover 62 to close the case 61.

The vibration motor 63 may include a stator 64 fitted to a sheet member 61a within the case 61, a rotor (not shown) rotatably disposed within the stator 64, and an eccentric shaft 65 connected to the rotor and rotating therewith. Thus, when the rotor is rotated, the eccentric shaft 65 is eccentrically rotated to generate vibration, so that the case 61 and the cover 62 are vibrated at the same time.

When the case 61 and the cover 62 are vibrated at a high frequency via eccentric rotation of the eccentric shaft 65, the resilient vibrating member 50 coupled to the case 61 is also vibrated forward and backward (in a back-and-forth motion) as indicated by a dash double-dot line in FIG. 3.

Hence, with the vibration structure or arrangement (including, for example, the vibrating member 50 and the vibration motor assembly 60 connected thereto) as described above, if dust is accumulated on the dust filter 20 through use of the air purifier 10 for a predetermined period of time, it is possible to remove the dust by operating the vibration motor 63. That is, when the vibration motor 63 is operated (e.g., by a user using an activation switch (not shown) provided on the air purifier housing 10 or automatically by a programmable timer operation), the vibrating member 50 is vibrated at a high frequency together with the case 61 and the cover 62 of the vibration motor assembly 60, and the resulting vibrational force is applied to the filtering portion 22 of the dust filter 20 at that high frequency.

As a result, the filtering portion 22 of the dust filter 20 also vibrates at the high frequency in a manner such that the dust particles and foreign substances attached to the filtering portion 22 are dropped and accumulated in the tray 25. Because the dust filter 20 is equipped at an angle in the housing 10 such that the upper end (i.e., the end hovering over the tray 25 as shown in the embodiment of FIG. 2) of the dust filter 20 is vertically closer to the tray 25 and because the dust filter 20 has the structure to prevent static electricity from accumulating on the filtering portion 22, the dust particles can be more rapidly and effectively detached from the filtering portion 22 and collected in the tray 25.

One of the utilities of the present general inventive concept is that the dust particles and foreign substances attached to the dust filter can be rapidly and effectively detached from the dust filter by vibrating the vibrating member and the dust filter through periodic operation of the vibration motor equipped near the rear surface of the dust filter. Because of such vibration arrangement, the dust filter is not required to be separated from the air purifier unit to manually remove the dust from the dust filter. This results in enhanced dust collecting performance by the dust filter because the dust flow resistance thereon is decreased via a periodic automatic dust removing operation (when the vibration motor is turned on or activated manually by a user or automatically at predetermined timing intervals). Hence, the air purifier of the present general inventive concept can be operated without noise while enhancing overall air purifying performance.

Another utility of the present general inventive concept is that, since the dust filter is equipped at a predetermined angle in the housing and has the surface treated to prevent static electricity from accumulating thereon, the dust particles can be more rapidly and effectively removed from the dust filter, thereby increasing the operational lifespan of the dust filter.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An air purifier comprising:
a housing that includes:
a dust filter;
a vibrating member placed adjacent to the dust filter and transferring vibratory motion thereto when the vibrating member is vibrated; and
a vibration motor assembly equipped to the vibrating member and configured to vibrate the vibrating member to remove dust attached to the dust filter.

2. The air purifier according to claim 1, wherein the dust filter is equipped at an angle within the housing such that an upper end of the dust filter is closer to a front side of the housing than a lower end of the dust filter, wherein the angle is measured from the vertical.

3. The air purifier according to claim 2, wherein the dust filter is equipped at an angle of approximately 10 to 45 degrees within the housing.

4. The air purifier according to claim 2, wherein the housing further includes a tray placed adjacent to the lower end of the dust filter to collect the dust that drops from the dust filter when the dust filter is vibrated by vibration of the vibrating member.

5. The air purifier according to claim 4, wherein the tray has a rear plate extending towards the lower end of the dust filter to prevent the dust collected in the tray from being scattered and then reattached to the dust filter.

6. The air purifier according to claim 1, wherein a surface of the dust filter is coated to prevent static electricity from accumulating thereon.

7. The air purifier according to claim 6, wherein the surface of the dust filter is coated with Teflon powder.

8. The air purifier according to claim 6, wherein the surface of the dust filter is coated with metallic powder.

9. The air purifier according to claim 1, wherein the housing further includes a motor-driven blowing fan placed at a rear portion of the housing behind the dust filter to blow air within the housing.

10. The air purifier according to claim 9, wherein the housing further includes a deodorizing filter removably placed between the dust filter and said blowing fan to facilitate deodorization of the air being purified by the air purifier.

11. The air purifier according to claim 10, wherein the housing further includes:
a first slot on an external side portion of the housing to allow the dust filter to be inserted into or removed from the housing; and
a second slot on the external side portion to allow the deodorizing filter to be inserted into or removed from the housing.

12. The air purifier according to claim 1, wherein the dust filter includes:
a rectangular frame; and
a filtering portion detachably fitted to the frame and made of a porous material to collect dust.

13. The air purifier according to claim 12, wherein at least one external surface of the filtering portion is coated to prevent static electricity from accumulating thereon.

14. A system comprising:
a housing that includes a first slot on an external side portion thereof;
a dust filter configured to be inserted into or removed from the housing through the first slot, wherein, upon insertion into the housing, the dust filter is placed at an angle within the housing such that an upper end of the dust filter is closer to a front side of the housing than a lower end of the dust filter, wherein the angle is measured from the vertical; and
a vibration unit placed inside the housing and adjacent to the dust filter when the dust filter is inserted into the housing, wherein the vibration unit is configured to remove dust attached to the dust filter through vibratory motion thereof.

15. The system according to claim 14, wherein the housing includes a second slot on the external side portion thereof, and wherein the system further comprises:
a deodorizing filter configured to be inserted into or removed from the housing through the second slot, wherein, upon insertion into the housing and during operation of the system, the deodorizing filter is configured to facilitate deodorization of the air filtered by the dust filter inside the housing.
